(19) United States
(12) Patent Application Publication
(10) Pub. No.: US 2009/0288303 A1
(43) Pub. Date: Nov. 26, 2009

(54) Supporting device for mounting a protective cover to shield a cutting blade of a cutting machine

(75) Inventor: Yi-Te Liao, Nantou (TW)

Correspondence Address: K&L Gates LLP, STATE STREET FINANCIAL CENTER, One Lincoln Street, BOSTON, MA, 02111-2950, US

(73) Assignee: P & F Brother Industrial Corporation, Taichung (TW)

(21) Appl. No.: 12/154,528

(22) Filed: May 23, 2008

(51) Int. Cl. B26B 29/04

(52) U.S. Cl. 30/293

(57) ABSTRACT

A supporting device is adapted for mounting a protective cover to shield a cutting blade of a cutting machine, and includes a tightening bolt fastened to a tightening surface of a mount member, a supporting frame adapted for holding the protective cover and having a guiding slot for passage of the bolt so as to be movable between a position of use and a retreat position, a movable tightening member sleeved on the bolt and having a biasing-force acquiring major wall, and an actuating member having an actuating body which is threadedly engaged with the bolt such that turning of the actuating body results in axial displacement of the actuating body to press or release the tightening member so as to tighten or loosen the supporting frame.

### BACKGROUND OF THE INVENTION

1. Field of the Invention

This invention relates to a supporting device for mounting a protective cover to shield a cutting blade of a cutting machine, more particularly to a supporting device which is easily operated to be tightened firmly to a position of use or a retreat position.

2. Description of the Related Art

In a conventional table cutting machine, such as a circular saw machine, a supporting device is disposed adjacent to a circular saw blade for mounting a protective cover to shield the circular saw blade. The supporting device is detachably disposed on a worktable so as not to obstruct specific working operation, such as cutting a slot in a workpiece.

Referring to FIG. 1, a conventional supporting device 10 includes a fixed mount unit 11, a tightening mount unit 12 movably disposed on the fixed mount unit 11, and a control unit 13 disposed between the fixed and tightening mount units 11,12. The fixed mount unit 11 has a fixed mount 111 secured on a tabletop (not shown) of a cutting machine. The fixed mount 111 has a sliding slot 112 in a side thereof for fitting of a tightening mount unit 12. The tightening mount unit 12 has a tightening plate 121 which is fitted to the sliding slot 112, a cam follower piece 122 which is embedded into the tightening plate 121, and a limiting pin 123 which extends outwardly of the tightening plate 121. The control unit 13 has a tightening bolt 131, a cam piece 132 which meshes with the cam follower piece 122, a handgrip 133 which extends radially from the cam piece 132, and a limiting protrusion 134 which is disposed on the cam piece 132 to abut against the limiting pin 123. A clearance is present between the tightening plate 121 and a side of the fixed mount 111 for accommodating a lower portion of a supporting frame 1. An upper portion of the supporting frame 1 is adapted to hold a protective cover (not shown). When the user operates the handgrip 133 to rotate the cam piece 132, the cam follower piece 122 is pressed toward the fixed mount 111 so as to tighten the supporting frame 1 for positioning the protective cover on the cutting machine. However, the cam piece 132 may be rotated to cause movement of the cam follower piece 122 away from the tightening plate 121 when the machine is vibrated during the cutting operation, thereby resulting in undesired detachment of the supporting frame 1 from the tightening mount unit 12.

Referring to FIG. 2, another supporting device 20 includes a mounting unit 21, a supporting frame unit 22 and a control unit 23. The mounting unit 21 has a fixed mount 211 and a tightening plate 212. The supporting frame unit 22 has a supporting frame 221 which is disposed between the fixed mount 211 and the tightening plate 212, and which has an arcuate slot 2211. The control unit 23 has a tightening bolt 231 which extends through the arcuate slot 2211 and into the fixed mount 211, two washers 232 which are sleeved on the tightening bolt 231, a guide pin 233 which is disposed on the tightening bolt 231, and a cam actuator 234 which is sleeved on the tightening bolt 231 at one end thereof, and which has a handgrip at the other end. The cam actuator 234 has a spirally extending groove 2341 which surrounds the tightening bolt 231 for guiding movement of the guide pin 233. Thus, when the user rotates the cam actuator 234, the cam actuator 234 can press the tightening plate 212 via the washers 232 towards the fixed mount 211 so as to tighten the supporting frame 221. However, undesired loosening of the supporting frame 221 may occur after long-term use.

### SUMMARY OF THE INVENTION

The object of the present invention is to provide a supporting device which is easily operated to be tightened firmly to a position of use or a retreat position relative to a cutting machine.

According to this invention, the supporting device includes a mount member adapted to be secured to a cutting machine. The mount member has a major abutment wall with a proximate tightening surface facing rearward. A tightening bolt includes a shank which has a front end fastened to the major abutment wall, a rear end opposite to the front end along an axis, and guided and threaded segments interposed between the front and rear ends. A supporting frame has an upper end adapted to hold a protective cover, and a middle segment which has proximate and distal tightened major surfaces, and a guiding slot that permits passage of the shank therethrough. The guiding slot is disposed to permit the middle segment to be movable between a position of use, where the shank is remote from the upper end, and a retreat position, where the shank is closer to the upper end. A movable tightening member is sleeved on and is in splined engagement with the guided segment, and includes a tightening major wall confronting the distal tightened major surface, and a biasing-force acquiring major wall that is configured to acquire, as a result of yielding of the biasing-force acquiring major wall to a pushing force, an urging force to counteract the pushing force. An actuating member includes an actuating body and a handgrip. The actuating body has a force-applying end wall confronting the biasing-force acquiring major wall, and an internally threaded surface threadedly engaged with the threaded segment to generate a frictional force such that, by virtue of splined engagement of the movable tightening member with the guided segment, turning of the internally threaded surface relative to the threaded segment results in axial displacement of the force-applying end wall between a loosening position, where the force-applying end wall is not in pressing engagement with the biasing-force acquiring major wall, and a tightening position, where the biasing-force acquiring major wall is pressed forward by the pushing force, thereby acquiring the urging force. The handgrip extends radially from the actuating body to facilitate turning of the actuating body so as to vest the force-applying end wall with the pushing force to place the biasing-force acquiring major wall in the tightening position, where the urging force biases the force-applying end wall to counteract the frictional force, thereby guarding the handgrip against angular movement away from the tightening position.

### BRIEF DESCRIPTION OF THE DRAWINGS

Other features and advantages of the present invention will become apparent in the following detailed description of the preferred embodiments of the invention, with reference to the accompanying drawings, in which:

FIG. 1 is a perspective view of a conventional supporting device;

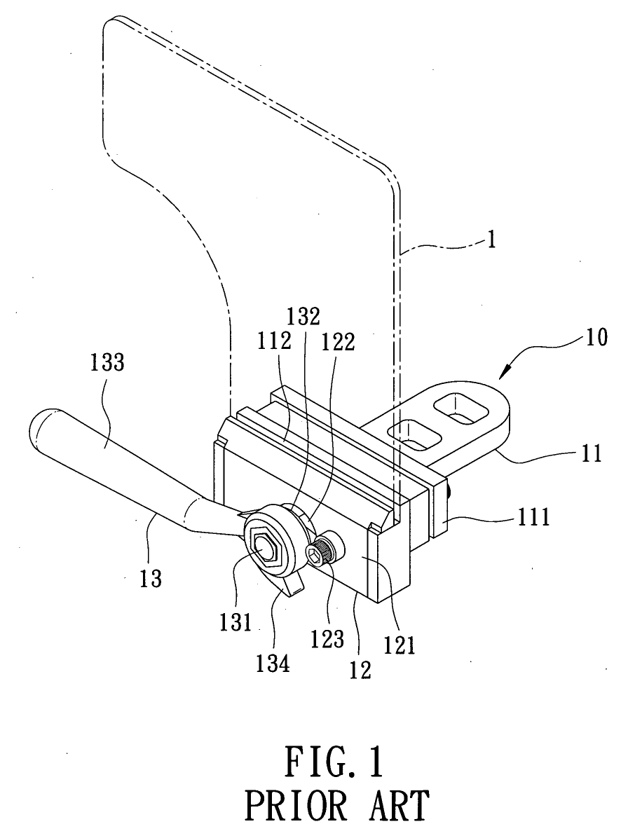

FIG. 2 is a perspective view of another conventional supporting device;

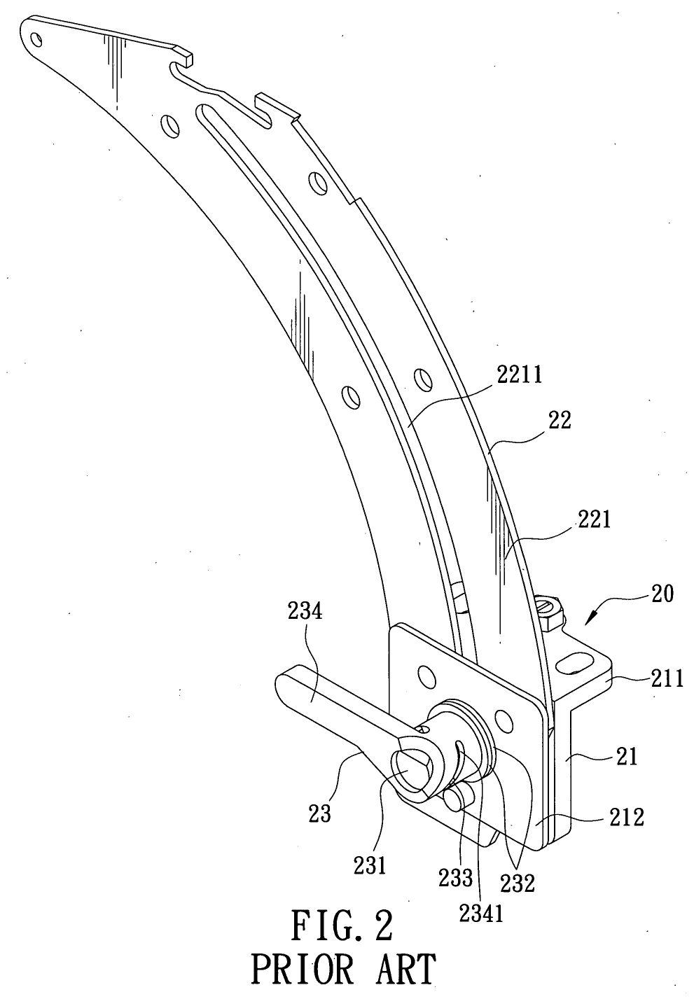

FIG. 3 is an exploded perspective view of a first preferred embodiment of a supporting device according to this invention;

FIG. 4 is a schematic side view of a first preferred embodiment showing an actuating member in a tightening position;

FIG. 5 is a schematic top view of the first preferred embodiment;

FIG. 6 is a sectional view of the first preferred embodiment taken along lines VI-VI of FIG. 4;

FIG. 7 is a sectional view of the first preferred embodiment taken along lines VII-VII of FIG. 4;

FIG. 8 is a sectional view of the first preferred embodiment taken along lines VIII-VIII of FIG. 4;

FIG. 9 is a fragmentary sectional view of the first preferred embodiment taken along lines IX-IX of FIG. 5;

FIG. 10 is a sectional view of the first preferred embodiment taken along lines X-X of FIG. 5;

FIG. 11 is a schematic side view of the first preferred embodiment showing the actuating member in a loosening position;

FIG. 12 is an exploded perspective view of a second preferred embodiment of a supporting device according to this invention;

FIG. 13 is an exploded perspective view of a third preferred embodiment of a supporting device according to this invention; and

FIG. 14 is an exploded perspective view of a fourth preferred embodiment of a supporting device according to this invention.

### DETAILED DESCRIPTION OF THE PREFERRED EMBODIMENTS

Before the present invention is described in greater detail, it should be noted that same reference numerals have been used to denote like elements throughout the specification.

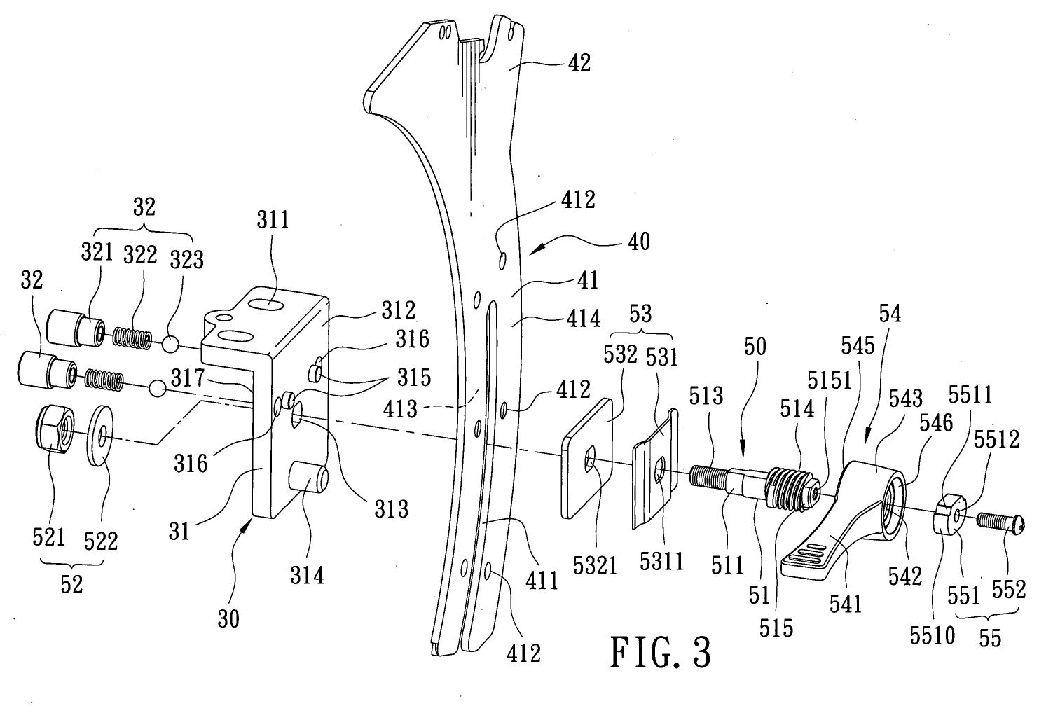

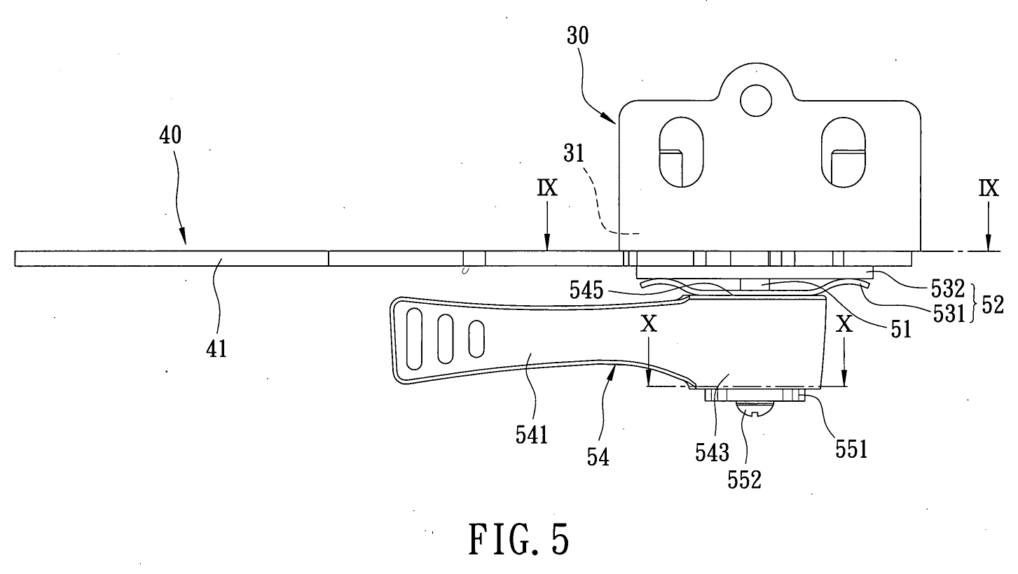

Referring to FIGS. 3 to 5, the first preferred embodiment of a supporting device according to the present invention is adapted to be mounted on a cutting machine (not shown), such as a table saw machine, for mounting a protective cover (not shown) to shield a cutting blade (not shown) of the cutting machine. The support device of this embodiment is shown to comprise a mount member 30, a tightening bolt 50, a supporting frame 40, a movable tightening member 53, an actuating member 54, and two biasing units 32.

The mount member 30 is adapted to be secured to the cutting machine, and includes a major abutment wall 31 which has a proximate tightening surface 312 facing rearward, a distal tightening surface 317 opposite to the proximate tightening surface 312, and a non-circular axial hole 313 extending through the proximate and distal tightening surfaces 312,317 along an axis. The mount member 30 further has two elongated positioning holes 311 for fastening the mount member 30 to the cutting machine. Further, the major abutment wall 31 has two through holes 316 extending through the proximate and distal tightening surfaces 312,317, and two retaining pins 315 and a sliding stud 314 extending rearwardly from the proximate tightening surface 312.

The tightening bolt 50 has a shank 51 which has a front end 513 extending through the axial hole 313 and threadedly engaged with a fastening member 52 that includes a screw nut 521 and a washer 522 so as to be fastened to the major abutment wall 31, a rear end 515 opposite to the front end 513 along the axis, and guided and threaded segments 511,514 that are interposed between the front and rear ends 513,515, and that are proximate to and distal from the front end 513, respectively. The guided segment 511 is inserted into the axial hole 313 in splined engagement therewith so as to prevent rotation of the shank 51 relative to the mount member 30. The threaded segment 514 is provided with multi-start threads, such as triple-start threads. The rear end 515 has a screw hole 5151.

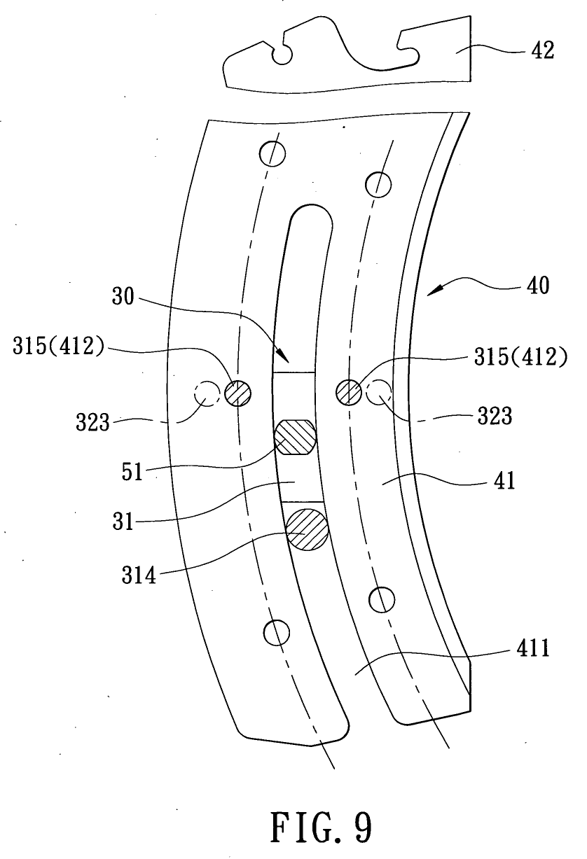

The supporting frame 40 has an upper end 42 adapted to hold the protective cover, and a middle segment 41 which extends downwardly from the upper end 42 and which has proximate and distal tightened major surfaces 413,414 opposite to each other along the axis, and a guiding slot 411 that extends through the proximate and distal tightened major surfaces 413,414 and that permits passage of the shank 51 therethrough. The middle segment 41 further has a plurality of retaining holes 412 that are disposed to respectively engage the retaining pins 315 so as to cooperatively serve as a retaining unit, as shown in FIG. 9. The guiding slot 411 is configured to permit the middle segment 41 to be movable between a position of use, where the shank 51 is remote from the upper end 42, and a retreat position, where the shank 51 is closer to the upper end 42.

The movable tightening member 53 is sleeved on and is in splined engagement with the guided segment 511 through spline holes 5311,5321, and includes a tightening major wall 532 in the form of a rectangular pad that confronts the distal tightened major surface 414, and a biasing-force acquiring major wall 531 in the form of a leaf spring that is opposite to the tightening major wall 532 along the axis.

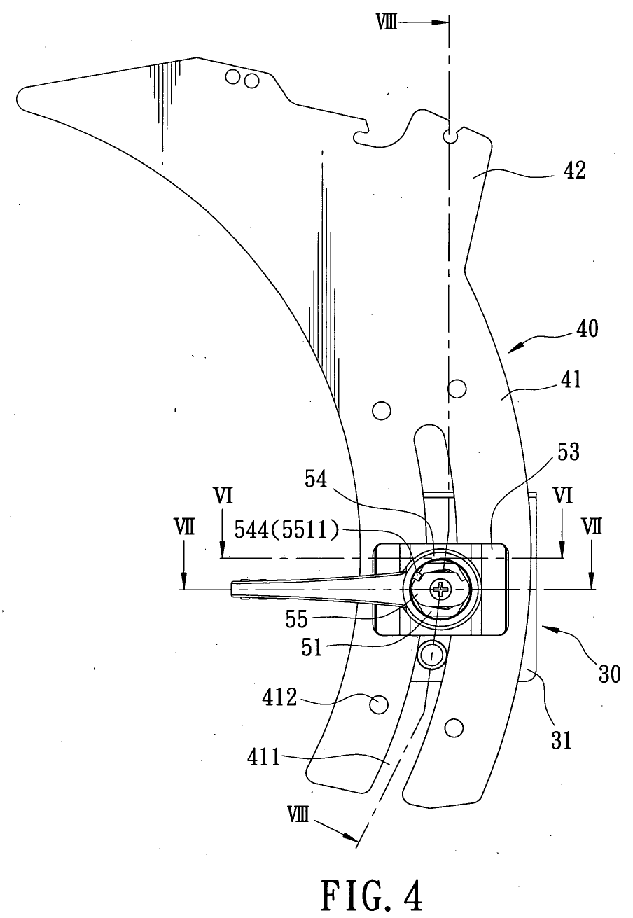

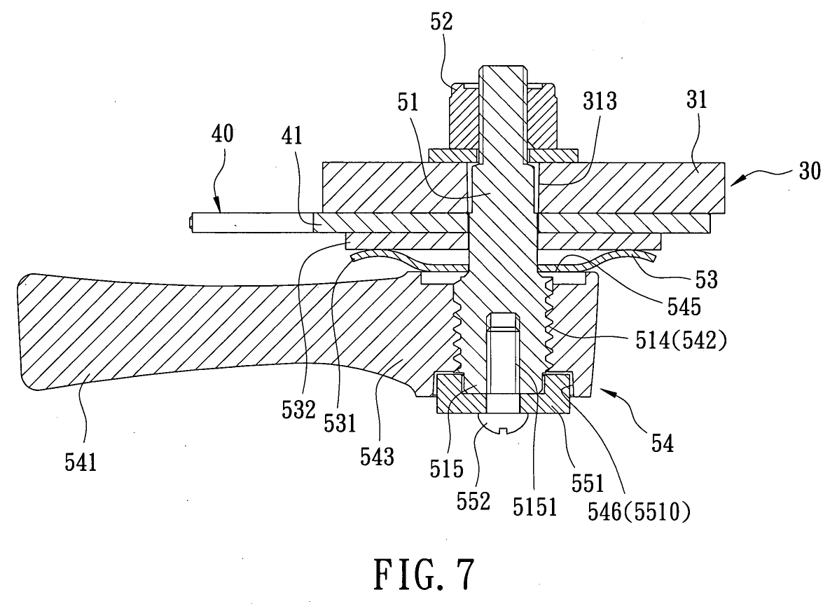

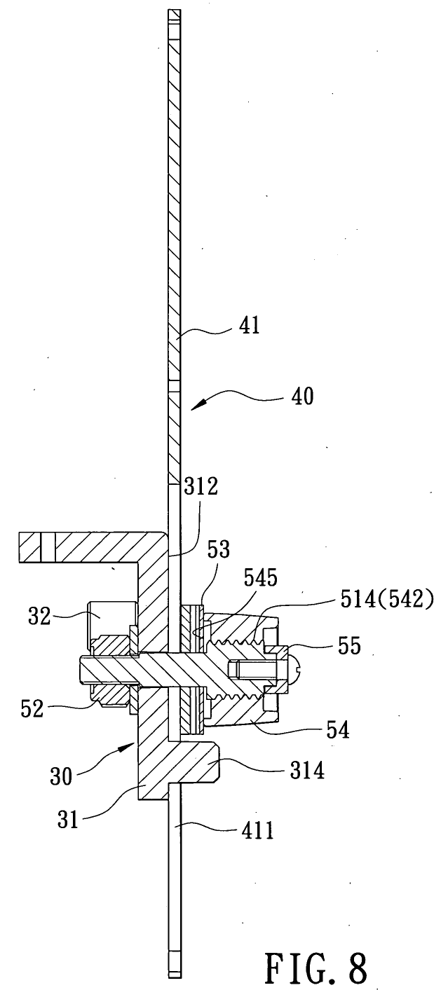

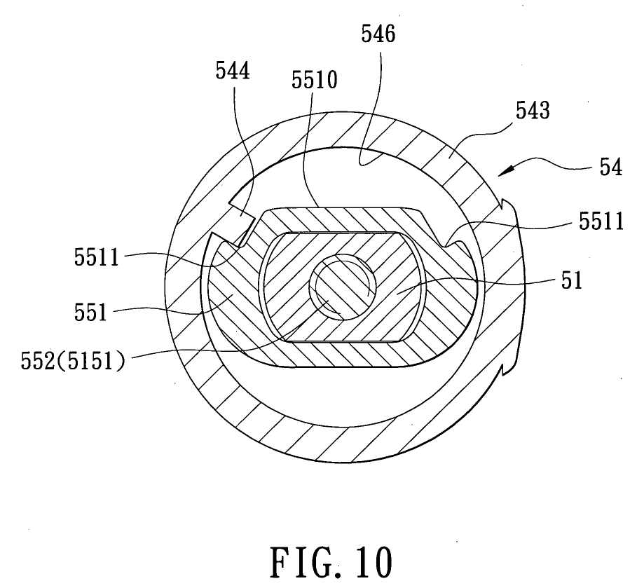

The actuating member 54 includes an actuating body 543 and a handgrip 541. The actuating body 543 has a force-applying end wall 545 which confronts the biasing-force acquiring major wall 531 and which is turnable about the axis, and an internally threaded surface 542 threadedly engaged with the threaded segment 514 of the shank 51. The handgrip 541 extends radially from the actuating body 543 to facilitate turning of the actuating body 543. Further, with reference to FIGS. 3, 7 and 8, the actuating body 543 has an inner annular seating surface 546 which surrounds the axis and which is disposed rearwardly of the internally threaded surface 542. The tightening bolt 50 has a limiting member 55 including a limiting block 551 which is mounted on the rear end 515 of the shank 51 and which has a rim 5510 surrounded by the inner annular seating surface 546, and a screw bolt 552 which passes through a hole 5512 in the limiting block 551 and is threadedly engaged with the screw hole 5151 so as to prevent detachment of the actuating member 54 from the shank 51. Furthermore, with reference to FIGS. 4 and 10, a limiting pin 544 is disposed on the inner annular seating surface 546. The rim 5510 defines a guideway for the limiting pin 544 to be slidable thereon when the actuating body 543 is turned about the axis. The rim 5510 has two retaining grooves 5511 which are disposed at two ends of the guideway, and which are angularly displaced from each other about the axis so as to locate the limiting pin 544.

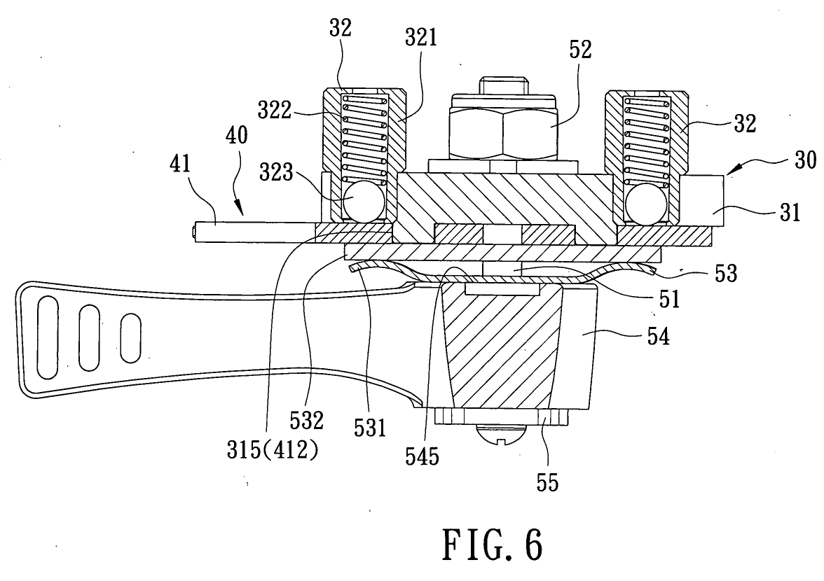

With reference to FIGS. 3 and 6, each of two biasing units 32 has a spring 322, a ball member 323 biased by the spring 322 and extending through the respective through hole 316 to bias the proximate tightened major surface 413 towards the movable tightening member 53, and a housing 321 for receiving the spring 322 and the ball member 323.

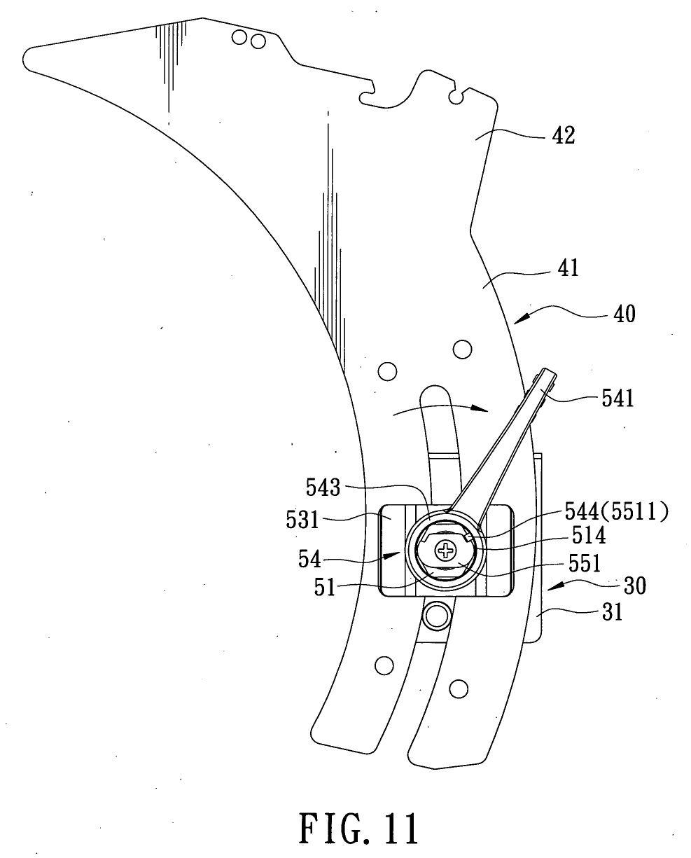

As illustrated above, referring to FIGS. 3, 4 and 11, when the handgrip 541 is operated to turn the actuating body 543, by virtue of the splined engagement of the movable tightening member 53 with the guided segment 511, turning of the internally threaded surface 542 relative to the threaded segment 514 results in axial displacement of the force-applying end wall 545 between a loosening position, as shown in FIG. 11, where the force-applying end wall 545 is not in pressing engagement with the biasing-force acquiring major wall 531, and a tightening position, as shown in FIGS. 4 to 8, where the biasing-force acquiring major wall 531 is pressed forward by the force-applying end wall 545 with a pushing force, and hence acquires an urging force to counteract the pushing force. On the other hand, the urging force biases the force-applying end wall 545 to counteract a frictional force generated by the threaded engagement of the threaded segment 514 with the internally threaded surface 542, thereby guarding the handgrip 541 against angular movement away from the tightening position. In addition, by virtue of the biasing units 32 which bias the supporting frame 40 to the movable tightening member 53, the urging force of the biasing-force acquiring major wall 531 is strengthened. Also, by means of the retaining unit, i.e., the retaining pins 315 and the retaining holes 412, the supporting frame 40 can be retained in the corresponding one of the position of use and the retreat position. Thus, the supporting frame 40 can be tightened firmly in the tightening position so as to hold a protective cover against vibration of the cutting machine during a cutting operation. Moreover, since the threaded segment 514 is formed with multi-start threads, a small angular movement of the handgrip 541 can result in displacement of the actuating body 543 over a relatively long distance, whereby the supporting frame 40 can be easily and quickly tightened to and loosened from the mount member 30.

Further, referring to FIGS. 4 and 11, due to the engagement of the limiting pin 544 with a respective one of the retaining grooves 5511, the actuating body 543 can be steadily placed in a selected one of the loosening and tightening positions, and turning of the actuating body 543 can be restricted within a certain range.

Further, the biasing force of the biasing-force acquiring major wall 531 is adjustable through threaded movement of the fastening member 52.

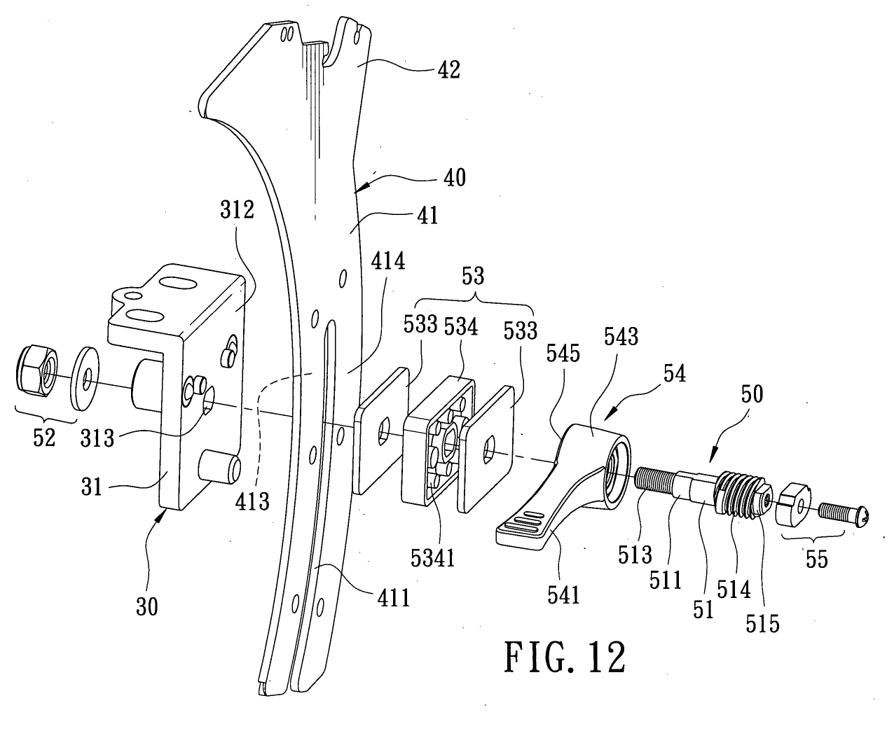

Alternatively, referring to FIG. 12, in the second preferred embodiment of the supporting device according to this invention, instead of the pad 532 and the leaf spring 531 used in the first embodiment, the movable tightening member 53 includes two elastic pads 533 that respectively serve as the tightening major wall and the biasing-force acquiring major wall, and a rectangular body 534 sandwiched between the elastic pads 533 and including a plurality of elastic posts 5341 which are stretchable along the axis so as to provide the biasing-force acquiring major wall with the urging force.

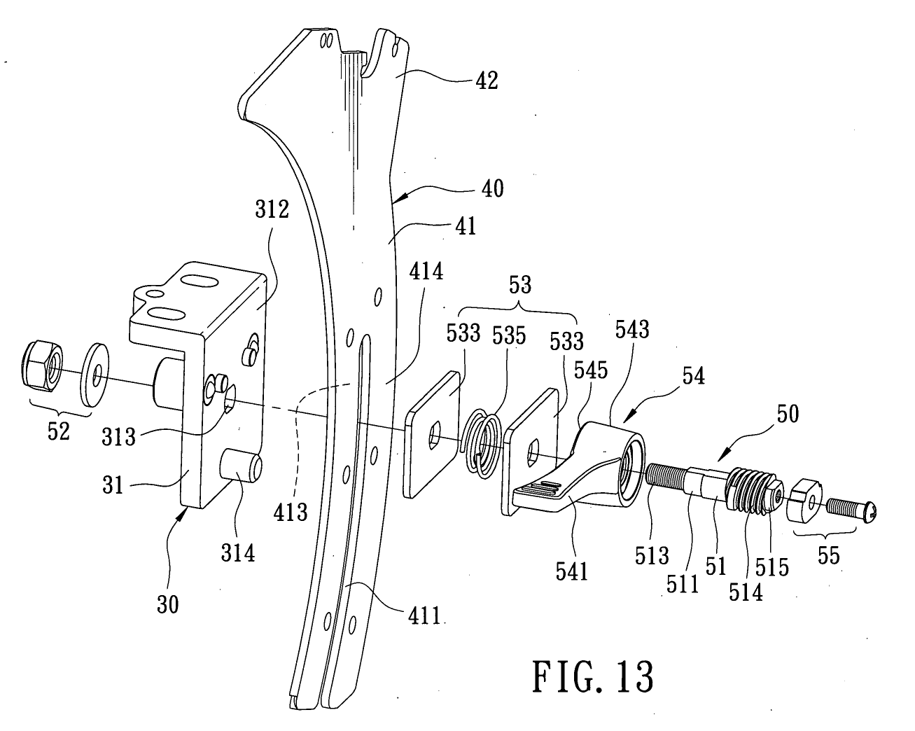

Referring to FIG. 13, in the third preferred embodiment of the supporting device according to this invention, the movable tightening member 53 includes two elastic pads 533 that respectively serve as the tightening major wall and the biasing-force acquiring major wall, and a coil spring 535 which is disposed between the elastic pads 533 so as to provide the biasing-force acquiring major wall with the urging force.

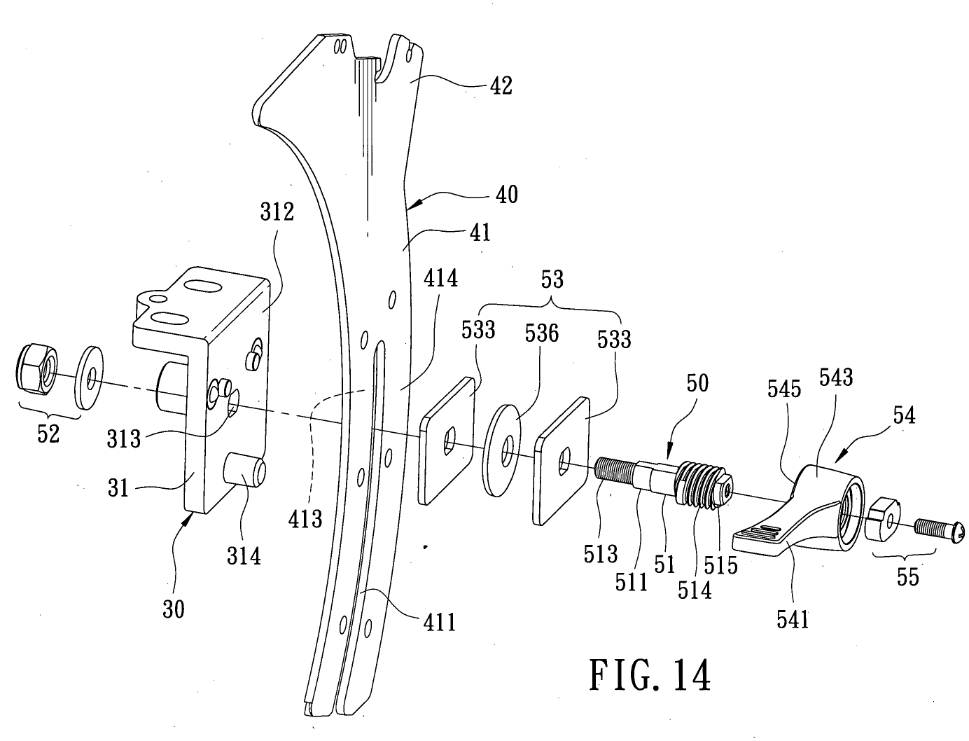

Referring to FIG. 14, in the fourth preferred embodiment of the supporting device according to this invention, the movable tightening member 53 includes two elastic pads 533 that respectively serve as the tightening major wall and the biasing-force acquiring major wall, and a leaf spring 536 which is disposed between the elastic pad 533 so as to provide the biasing-force acquiring major wall with the urging force.

While the present invention has been described in connection with what are considered the most practical and preferred embodiments, it is understood that this invention is not limited to the disclosed embodiments but is intended to cover various arrangements included within the spirit and scope of the broadest interpretations and equivalent arrangements.

I claim:

1. A supporting device for mounting a protective cover to shield a cutting blade of a cutting machine, said supporting device comprising:
a mount member which is adapted to be secured to the cutting machine, said mount member including a major abutment wall which has a proximate tightening surface facing rearward;
a tightening bolt having a shank which has a front end fastened to said major abutment wall, a rear end opposite to said front end along an axis, and guided and threaded segments that are interposed between said front and rear ends, and that are proximate to and distal from said front end, respectively;
a supporting frame which has an upper end adapted to hold the protective cover, and a middle segment which extends downwardly from said upper end and which has proximate and distal tightened major surfaces opposite to each other along the axis, and a guiding slot that extends through said proximate and distal tightened major surfaces and that permits passage of said shank therethrough, said guiding slot permitting said middle segment to be movable between a position of use, where said shank is remote from said upper end, and a retreat position, where said shank is closer to said upper end;
a movable tightening member which is sleeved on and which is in splined engagement with said guided segment, and which includes a tightening major wall that confronts said distal tightened major surface, and a biasing-force acquiring major wall that is opposite to said tightening major wall along the axis, and that is configured to acquire, as a result of yielding of said biasing-force acquiring major wall to a pushing force, an urging force to counteract the pushing force; and
an actuating member including
an actuating body which has a force-applying end wall that confronts said biasing-force acquiring major wall, and that is turnable about the axis, said actuating body having an internally threaded surface threadedly engaged with said threaded segment to generate a frictional force such that, by virtue of splined engagement of said movable tightening member with said guided segment, turning of said internally threaded surface relative to said threaded segment results in axial displacement of said force-applying end wall between a loosening position, where said force-applying end wall is not in pressing engagement with said biasing-force acquiring major wall, and a tightening position, where said biasing-force acquiring major wall is pressed forward by the pushing force, thereby acquiring the urging force, and
a handgrip which extends radially from said actuating body to facilitate turning of said actuating body so as to vest said force-applying end wall with the pushing force to place said biasing-force acquiring major wall in the tightening position, where the urging force biases said force-applying end wall to counteract the frictional force, thereby guarding said handgrip against angular movement away from the tightening position.

2. The supporting device according to claim 1, wherein said threaded segment of said shank is provided with multi-start threads.

3. The supporting device according to claim 1, wherein said major abutment wall has a distal tightening surface opposite to said proximate tightening surface, and an axial hole extending through said proximate and distal tightening surfaces, said front end of said shank being configured to non-rotatably pass through said axial hole.

4. The supporting device according to claim 3, further comprising a fastening member which is configured to threadedly fasten said front end to said mount member.

5. The supporting device according to claim 3, wherein said major abutment wall has two through holes extending through said proximate and distal tightening surfaces, said supporting device further comprising two biasing units, each of which has a spring-loaded ball member disposed to extend through a respective one of said through holes to bias said proximate tightened major surface towards said movable tightening member so as to strengthen the urging force.

6. The supporting device according to claim 1, wherein said actuating body has an inner annular seating surface which surrounds the axis, and which is disposed rearwardly of said internally threaded surface, and a limiting pin which is disposed on said inner annular seating surface, said tightening bolt having a limiting member which is mounted on said rear end of said shank and which has a rim that is surrounded by said inner annular seating surface, and that defines a guideway for said limiting pin to be slidable thereon when said actuating body is turned about the axis, said rim being configured to have two retaining grooves which are disposed at two ends of said guideway, and which are angularly displaced from each other about the axis so as to locate said limiting pin, thereby ensuring placement of said actuating body in a selected one of the loosening and tightening positions.

7. The supporting device according to claim 1, wherein said biasing-force acquiring major wall is in form of a leaf spring.

8. The supporting device according to claim 1, wherein said movable tightening member includes a plurality of elastic posts which are stretchable along the axis, and which are interposed between said tightening and biasing-force acquiring major walls so as to provide said biasing-force acquiring major wall with the urging force.

9. The supporting device according to claim 1, wherein said movable tightening member includes a coil spring which is disposed between said tightening and biasing-force acquiring major walls so as to provide said biasing-force acquiring major wall with the urging force.

10. The supporting device according to claim 1, wherein said movable tightening member includes a leaf spring which is disposed between said tightening and biasing-force acquiring major walls so as to provide said biasing-force acquiring major wall with the urging force.

11. The supporting device according to claim 1, further comprising a retaining unit which is disposed between said proximate tightening surface of said mount member and said proximate tightened major surface of said supporting frame and which is configured to detachably retain said supporting frame in a corresponding one of the position of use and the retreat position.
